(19) United States
(12) Patent Application Publication
(10) Pub. No.: US 2008/0029681 A1
(43) Pub. Date: Feb. 7, 2008

(54) Base Isolation Structure

(76) Inventors: Masayoshi Kawata, Shinjuku-ku (JP); Yoji Izumo, Shinjuku-ku (JP); Yosuke Fukumoto, Shinjuku-ku (JP)

Correspondence Address: WENDEROTH, LIND & PONACK, L.L.P., 2033 K STREET N. W., SUITE 800, WASHINGTON, DC, 20006-1021, US

(21) Appl. No.: 11/579,738

(22) PCT Filed: May 13, 2005
(86) PCT No.: PCT/JP05/08746

§ 371 Date: Nov. 7, 2006

(30) Foreign Application Priority Data
May 17, 2004 (JP) 2004-146189
May 10, 2005 (JP) 2005-137100

(51) Int. Cl. F16F 15/00; F16F 9/00

(52) U.S. Cl. 248/638

(57) ABSTRACT

A base isolation structure capable of securing stable operation since there is no such a possibility that micro-vibration usually produced does not exceed a requested allowable vibration value by developing base isolating effects in earthquake to prevent heavy damages from occurring and effectively isolating a structure in which vibration-sensitive equipments are disposed such as a semiconductor manufacturing plant from earthquake. A base isolation device (4) by a rigid sliding bearing having such a rigidity in the vertical and horizontal directions that micro vibration transmitted to the structure (1) can be reduced to a value smaller than the allowable vibration value determined according to the degree of the reluctance of the equipments is disposed between the structure (1) in which the micro vibration-sensitive equipments are disposed and the foundation (3) of the structure.

### TECHNICAL FIELD

The present invention relates to a base isolation (seismic isolation) structure suitable for providing base isolation ability for a structure in which various vibration-sensitive equipments are disposed, especially for a semiconductor manufacturing plant.

### BACKGROUND ART

Conventionally, a variety of structures have adopted a base isolation structure in which a stress or deformation produced in a frame of a structure may be reduced by providing a base isolation device in a foundation portion of the structure for damping vibration due to an earthquake etc. transmitted from the ground up to the structure.

In Japanese Patent Laid-Open No. 11-36657, a conventional base isolation structure of such type is shown, and this includes; a base isolation device disposed between a foundation and a building located above the foundation and including a laminated rubber for providing restoring force generated from predetermined force bouncing against a horizontal displacement of the building relative to the foundation while elastically supporting the building; a vertical damper disposed vertically between the foundation and the building and having a primary axis of damping force in the axial direction; and a horizontal damper disposed horizontally between the foundation and the building and having a primary axis of damping force in the horizontal direction.

According to the base isolation structure described above, conversion of the building's own natural period to a longer period by using the base isolation device having the laminated rubber can effectively cut off an external vibrational force due to an earthquake and the like from the foundation. Also, the vertical damper can damp vertical vibration of the building by compressive deformation of the laminated rubber, and the horizontal damper can damp horizontal relative displacement generated between the building and the foundation.

Meanwhile, many manufacturing equipments negatively affected by vibrations may be disposed in some of the structures such as a semiconductor manufacturing plant and a precision machine factory.

In such structures, damage to the manufacturing equipments or shutdown of operation caused by an earthquake may result in excessive loss, since the manufacturing equipments are expensive and high value-added products are produced.

Therefore, it may be conceivably intended to provide, also, the structure such as the semiconductor manufacturing plant with base isolation ability (quake-absorbing ability) by applying the base isolation device using the laminated rubber described above. However, since the base isolation device using the laminated rubber is originally configured to absorb horizontal relative displacement generated by an earthquake with the aid of elasticity of the rubber and expand the building's natural period to a longer period to reduce an earthquake effect, the lower the rigidity is set to, the building's natural period relative to the ground can be made longer.

On the contrary, when the base isolation device using the laminated rubber is placed between the building and its foundation, horizontal displacement caused by micro-vibration usually produced may be amplified by the base isolation device, since the horizontal rigidity of the base isolation device is low.

However, in the structures of this type, an allowable vibration value applied to a floor is strictly limited, because micro-vibration of the floor may adversely affect manufacturing equipments for micro-fabrication to pose a problem for production. Therefore, there is a disadvantage that the base isolation structure described above can not be employed for a structure such as a semiconductor manufacturing plant etc.

### DISCLOSURE OF THE INVENTION

The present invention has been made in consideration of the situation described above, and its object is to provide abase isolation structure capable of securing stable operation since there is no such a possibility that micro-vibration usually produced does not exceed a requested allowable vibration value, and in earthquake, preventing heavy damages from occurring by developing base isolating effects, and thereby effectively isolating a structure in which vibration-sensitive equipments are disposed such as a semiconductor manufacturing plant from earthquake.

In order to achieve the object described above, according to a first aspect of the present invention, there is provided abase isolation structure comprising: a structure having micro vibration-sensitive equipments; a foundation of the structure; and at least one base isolation device between the structure and the foundation, wherein the base isolation device has a rigid sliding bearing and a rigidity in vertical and horizontal directions such that micro-vibration transmitted to the structure is less than an allowable vibration value determined according to the degree of the reluctance of the micro vibration-sensitive equipments. The “micro-vibration transmitted” means micro-vibration which is transmitted from the foundation side via the base isolation device to the structure and micro-vibration which is generated by an air conditioner and the like inside the structure.

Meanwhile, if rigidity (K₁) of the base isolation device at micro-vibrating is not known, a weight of mass (M₁) is supported on a floor via the base isolation device, normally present micro-vibrations at the floor and the weight are measured by acceleration sensors etc. set on the floor and the weight, and then, a natural frequency (f₁) is derived from the ratio between both measurements, and subsequently, the rigidity (K₁) may be obtained by using the following expression:
K₁=(2πf₁)²M₁

A second aspect of the present invention is characterized in that the allowable vibration value is not greater than 1.0 μm and a horizontal natural frequency of a base isolation layer formed by the base isolation device is set to not less than 3 Hz. Further, a third aspect of the present invention is characterized in that the allowable vibration value is not greater than 0.5 μm and a horizontal natural frequency of a base isolation layer formed by the base isolation device is set to not less than 4 Hz.

In the second and third aspects, it is intended to satisfy the allowable vibration value by suppressing displacement response due to resonance of the structure to be small, with taking into consideration the relation between the horizontal natural frequency of the base isolation layer, arranged by disposing the base isolation device using the rigid sliding bearing according to the first aspect, in normal conditions and displacement response of the structure.

That is, the natural frequency f₀ (Hz) of the base isolation layer is represented as follows:
f₀=1/(2π)×(K₀·g/M₀)^{1/2}
Where, K₀ is the rigidity (tf/cm) of the base isolation layer in normal conditions, M₀ is the mass (t) of the structure, and g is the gravitational acceleration (980 cm/s²).

Assuming that h is a damping factor of the base isolation layer, A₁ (gal) is acceleration under the base isolation layer, A₂ (gal) is acceleration on the top of the base isolation layer and D₂ (μm) is displacement of the top of the base isolation layer, acceleration response at a resonance point of the structure may be computed by the following expression:

$$\begin{matrix}[ Formula 1 ] & \\ {A}_{2} = \sqrt{\frac{1 + 4 {h}^{2}}{4 {h}^{2}}} \times {A}_{1} & ( 1 )\end{matrix}$$

The acceleration response at the resonance point of the structure derived from the expression (1) will become constant regardless of the natural frequency of the base isolation layer, then this result may be transformed to displacement response by using the expression (2) described below, and the resultant displacement response at the resonance point of the structure is inversely proportional to the square of the frequency.

$$\begin{matrix}[ Formula 2 ] & \\ {D}_{2} = \frac{1}{{( 2 π {f}_{0} )}^{2}} {A}_{2} \times {10}^{4} & ( 2 )\end{matrix}$$

Therefore, if the horizontal natural frequency of the base isolation layer is set to a value not less than a constant value, the displacement response at the resonance point of the structure can be suppressed, and as a result, the displacement response not greater than the allowable vibration value requested in the structure can be achieved.

Next, the limiting reason for why, in the second aspect of the present invention, when the allowable vibration value is not greater than 1.0 μm, the horizontal natural frequency of the base isolation layer is set to not less than 3 Hz, and in the third aspect of the present invention, when the allowable vibration value is not greater than 0.5 μm, the horizontal natural frequency of the base isolation layer is set to not less than 4 Hz will be explained.

Based on the collected data from the past vibration study results, the acceleration A₁ of a typical ground under the base isolation layer is set to 0.002 gal, and the damping factor h of the base isolation layer is set to 5%, respectively. Next, from these values, the acceleration A₂ on the top of the base isolation layer is computed by the expression (1), and moreover, relation between the horizontal natural frequency f₀ (Hz) of the base isolation layer and the displacement D₂ (μm) of the top of the base isolation layer (the structure) is derived from the obtained acceleration A₂ and the expression (2), resulting in a graph shown in FIG. 8.

It can be seen in FIG. 8 that if the horizontal natural frequency f₀ of the base isolation layer is set to not less than 3.0 Hz and not less than 4.0 Hz, respectively, and when the allowable vibration value of the structure is 1.0 μm and 0.5 μm, respectively, the displacement response caused by the micro-vibration may sufficiently fall into not greater than the allowable vibration value, and therefore, the range of the values is selected.

Further, the horizontal natural frequency f₀ of the base isolation layer may be set to not less than the values described above by, mainly, selecting the number of the base isolation device using the rigid sliding bearing relative to the weight of the structure and setting an area of the base isolation device to a suitable value.

Further, a fourth aspect of the present invention is characterized in that, in any one of the first to third aspects of the present invention, a friction coefficient of the base isolation device using the rigid sliding bearing is not greater than 0.02, and further, a damping device for damping horizontal relative displacement is provided between the structure and the foundation.

Further, a fifth aspect of the present invention is characterized in that the base isolation device using the rigid sliding bearing has sliding surfaces facing one another, and each of the sliding surfaces is made of polytetrafluoroethylene.

The base isolation device, generally, as shown in FIG. 7, will have smaller amplitude of vibration transmitted as the rigidity thereof goes larger and on the contrary, have larger amplitude of vibration transmitted as the rigidity goes smaller.

Then, according to any one of the first to fifth aspects of the present invention, since a base isolation device adopting a rigid sliding bearing and having such a rigidity in vertical and horizontal directions that micro-vibration transmitted to a structure is not greater than an allowable vibration value determined according to vibration-sensitive equipments is disposed between the structure and its foundation, micro-vibration transmitted from the foundation side via the base isolation device to the structure and micro-vibration generated inside the structure can be kept to be not greater than the allowable vibration value in normal conditions.

Consequently, the base isolation device may not have a negative effect when it receives the micro-vibration generated in normal conditions, and a stable operation can be secured.

On the contrary, in an earthquake, since base isolation effect is developed by sliding of the base isolation device using the rigid sliding bearing, large damage to the structure can be prevented from occurrence, for example by preventing equipments from falling down or the structure from damage.

Further, according to the second or third aspect of the present invention, when the allowable vibration value of the structure is not greater than 1.0 μm or not greater than 0.5 μm, it is secured that the displacement response caused by resonance of the structure can be suppressed small to be not greater than the allowable vibration value, by selecting the number of the base isolation device using the rigid sliding bearing and/or its area to set the horizontal natural frequency of the base isolation layer to not less than 3 Hz or not less than 4 Hz.

In a base isolation structure of an ordinary building, a base isolation device based on an elastic sliding bearing is widely used. This is for the purpose of alleviating rapid change in rigidity upon occurrence of sliding at a base isolation layer and reducing acceleration acting on the structure by elastic deformation of an elastic body before sliding occurs against a horizontal force acting on in an earthquake, as shown by a dotted line in a graph of the upper side of FIG. 9.

On the contrary, when a base isolation layer is formed by only the base isolation device using the rigid sliding bearing as a base isolation device based on a sliding bearing, as in the first to third aspects of the present invention, an initial rigidity will become very large as shown by a continuous line in the graph, and therefore, because of rapid change in rigidity upon occurrence of sliding, acceleration response generated in the structure may become too large.

On this point, a friction coefficient of sliding surfaces formed between a stainless steel plate and polytetrafluoroethylene plate used in the base isolation device based on a normal sliding bearing is about 0.1. However, according to the fourth aspect of the present invention, since the friction coefficient of the sliding surface is set to not greater than 0.02, a small horizontal force acting on in an earthquake will initiate sliding, and therefore, an input itself to the structure on the base isolation device may be reduced and acceleration response generated in the structure can be decreased. In addition, since the damping device for damping horizontal relative displacement is disposed between the structure and its foundation, the relative displacement can be reduced even if sliding occurs early.

As a result, because both of large rigidity achieved by using the rigid sliding bearing in normal conditions and small rigidity in an earthquake can be satisfied, it may be secured that deformation of the structure caused by the micro-vibration in normal conditions is reduced to not more than the allowable vibration value, and in addition, the acceleration response of the structure in an earthquake can be suppressed to be small.

Especially, as in the fifth aspect of the present invention, if the sliding surfaces of the base isolation device using the rigid sliding bearing are made of polytetrafluoroethylene, respectively, then suitably, a friction coefficient at the sliding surfaces can be as small as about 0.013, even though general-purpose material is used.

### BRIEF DESCRIPTION OF THE DRAWINGS

FIG. 1 is a longitudinal cross sectional view of one embodiment of the present invention;

FIG. 2 is a longitudinal cross sectional view of a base isolation device using a rigid sliding bearing shown in FIG. 1;

FIG. 3A is a graph illustrating relation between force acting on the base isolation device in FIG. 2 and vertical deformation;

FIG. 3B is a graph illustrating relation between force acting on the base isolation device in FIG. 2 and horizontal deformation;

FIG. 4 is a longitudinal cross sectional view of the base isolation device using a laminated rubber bearing containing a lead plug shown in FIG. 1;

FIG. 5A is a graph illustrating relation between force acting on the base isolation device in FIG. 4 and vertical deformation;

FIG. 5B is a graph illustrating relation between force acting on the base isolation device in FIG. 4 and horizontal deformation;

FIG. 6 is an enlarged view of an attaching portion of an oil damper in FIG. 1;

FIG. 7 is a graph illustrating relation between rigidity at the base isolation device and amplitude of micro-vibration;

FIG. 8 is a graph illustrating relation between a horizontal natural frequency of a base isolation layer and displacement of a structure on the base isolation layer; and

FIG. 9 are graphs illustrating relation between force acting on the base isolation devices using an elastic sliding bearing or the rigid sliding bearing and horizontal deformation, and relation between force acting on a damping device such as an oil damper and a horizontal speed.

### DESCRIPTION OF SYMBOLS

1 Semiconductor manufacturing plant (structure)
2a, 2b, 2c, 2d Support frame
3 Foundation
4 Base isolation device using a rigid sliding bearing
5 Sliding plate
8a Sliding surface
10 Base isolation device using a laminated rubber bearing containing a lead plug
11 Rubber
12 Steel plate
13 Lead plug
15 Oil damper (damping device)
A₁ Vibration-sensitive area
A₂ The other area

### BEST MODE FOR CARRYING OUT THE INVENTION

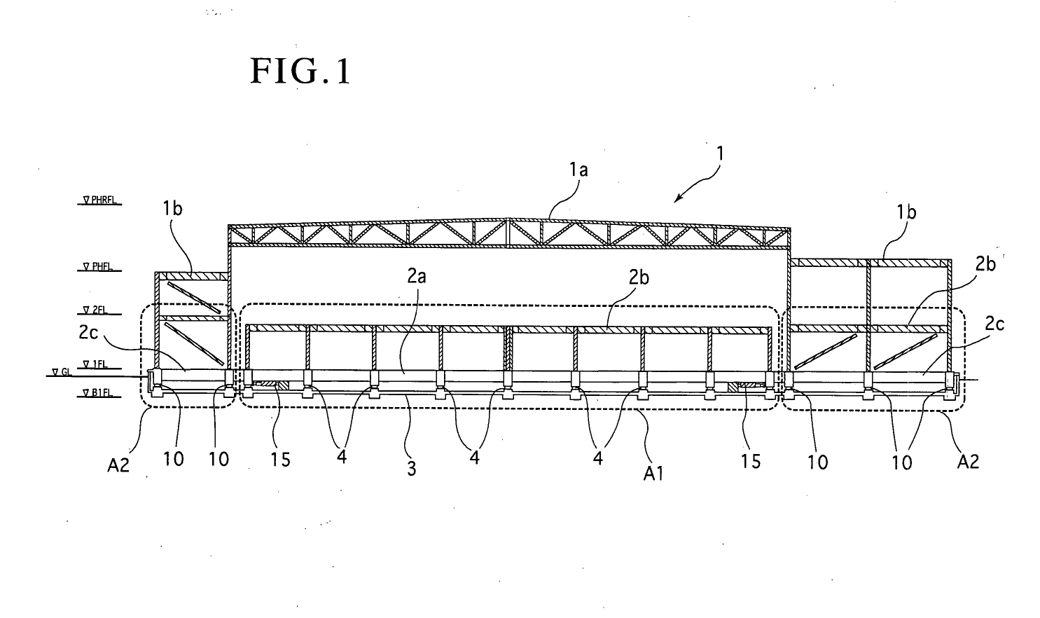

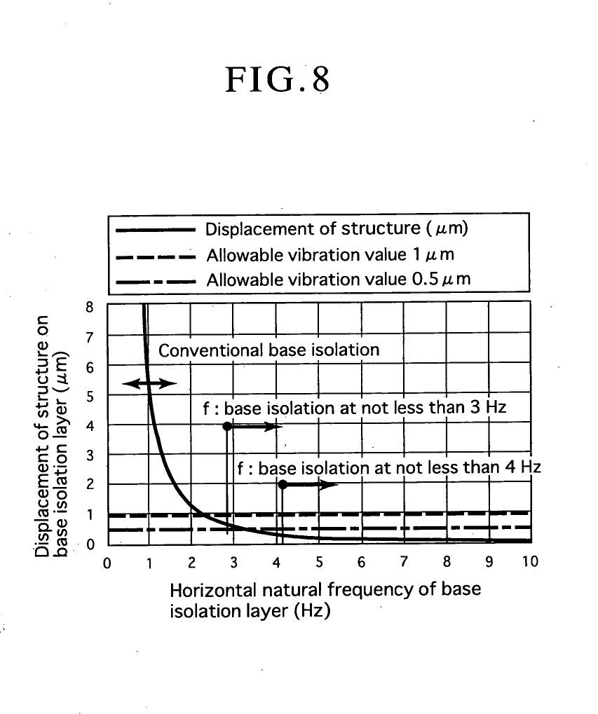

FIGS. 1 to 9 show one embodiment in which a base isolation structure according to the present invention is applied to a base isolation structure for a semiconductor manufacturing plant, and the semiconductor manufacturing plant (structure) is denoted by the reference numeral 1 in drawings.

This plant 1 includes a wide variety of micro vibration-sensitive equipments for manufacturing semiconductors disposed on a support frame 2b set up inside a building 1a and accessories disposed on a support frame 2a. Further, various equipments having a comparatively large allowable vibration value are disposed on a support frame 2d inside a building 1b adjacent to the building 1a described above and accessories such as generating machinery are disposed on a support frame 2c.

Accordingly, the plant 1 is partitioned off into a vibration-sensitive area A₁ defined by the support frames 2a and 2b having a small allowable vibration value, and the other area A₂ defined by the support frames 2c and 2d having a larger allowable vibration value.

Moreover, base isolation devices 4 using a rigid sliding bearing are placed between the support frame 2a and a foundation 3 in the vibration-sensitive area A₁.

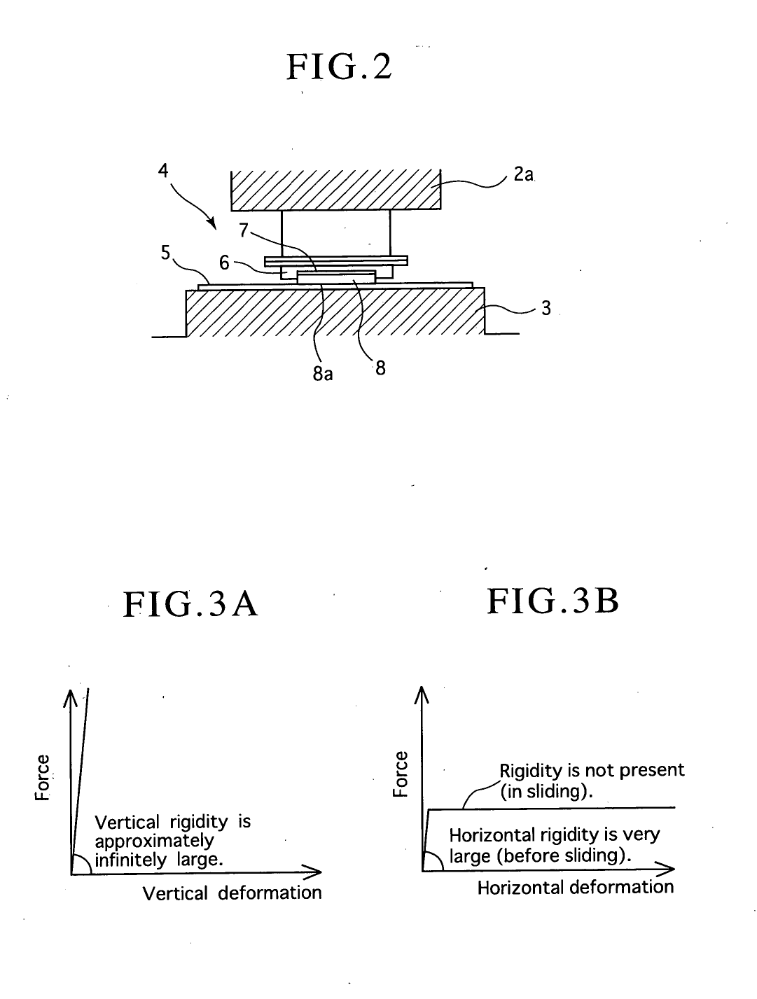

As shown in FIG. 2, the base isolation device 4 using the rigid sliding bearing is constituted by: fixing a sliding plate 5 made of a polytetrafluoroethylene (Teflon®) coating plate on the foundation 3; fixing a base pot 6 on the under surface of the support frame 2a; and fitting a base 8 made of a steel plate, whose under sliding surface 8a is coated with polytetrafluoroethylene, into a concave portion of the under surface of the base pot 6 via an inside rubber portion 7 for absorbing a rotational movement of the foundation 3.

This base isolation device 4 uses polytetrafluoroethylene for both the sliding plate 5 and the sliding surface 8a, resulting in the friction coefficient being set to as low as about 0.013, and consequently, when a horizontal force larger than the frictional force between the sliding plate 5 and the sliding surface 8a is acted on between them in an earthquake, vibration transmitted from the foundation 3 to the support frame 2a can be alleviated due to occurrence of sliding between the sliding plate 5 and the base 8.

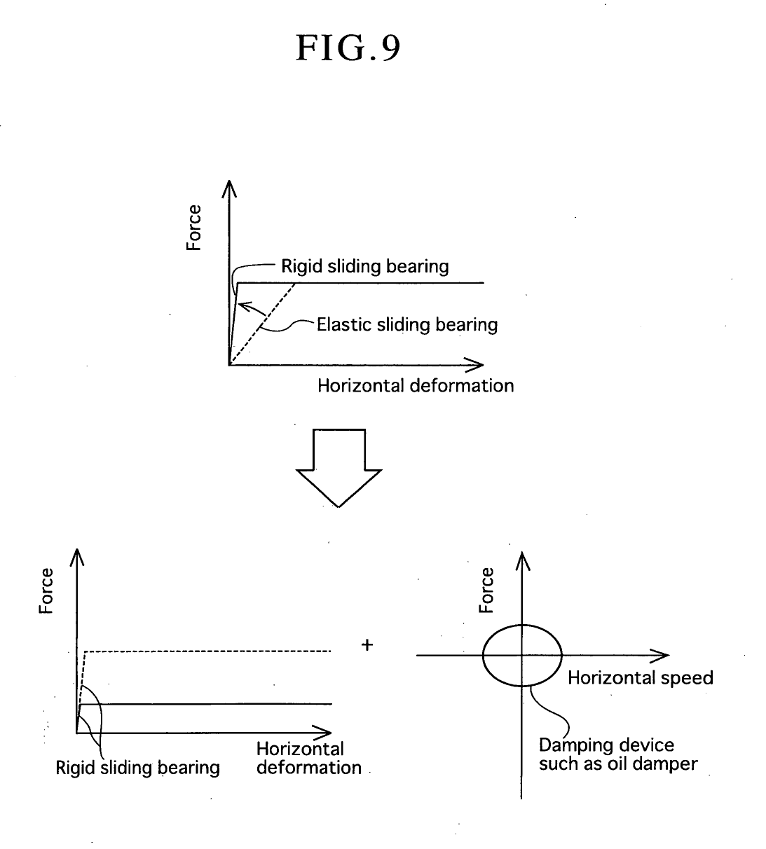

Therefore, as shown in FIGS. 3A, 3B and 9, extremely large rigidity may be exhibited in both the vertical and horizontal directions for micro-vibration which will not cause sliding between both sides. The specifications of each of components may be designed so that vibration transmitted to the support frame 2a due to the micro-vibration usually produced is not greater than the allowable vibration value in the vibration-sensitive area A₁.

In addition, when the allowable vibration value in the plant 1 is not greater than 1.0 μm, the number of the base isolation device 4 and its bearing area (an area of the sliding surface 8a) may be selected so that a horizontal natural frequency of a base isolation layer composed of the base isolation device 4 and the like is not less than 3 Hz, and also when the allowable vibration value is not greater than 0.5 μm, they are selected so that a horizontal natural frequency is not less than 4 Hz.

Further, base isolation devices 10 using a laminated rubber bearing containing a lead plug are placed between the support frame 2c and the foundation 3 in the other area A₂.

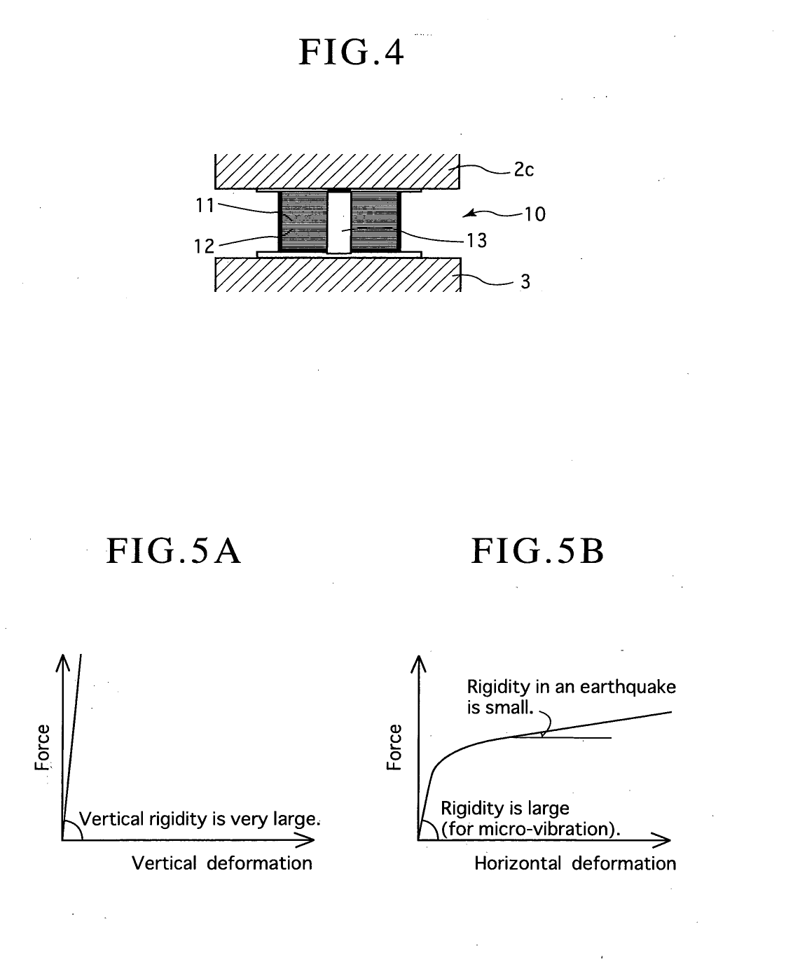

The base isolation device 10, as shown in FIG. 4, includes an integrated body having rubbers 11 and steel plates 12 alternatively laminated and a lead plug 13 fitted in a hole formed in the center portion thereof.

In the base isolation device 10 described above, compared to the base isolation device using the laminated rubber bearing comprising the rubber 11 and steel plate 12, extremely high rigidity will be expressed until the lead plug 13 becomes plastic state completely. Accordingly, as shown in FIGS. 5A and 5B, high rigidity in the vertical direction is expressed, and even in the horizontal direction, because the lead plug 13 provides a large resistance and also the laminated rubber is dependent on a strain, high rigidity for micro-vibration can be achieved.

Then, also in this base isolation device 10, specifications of each of the components are designed so that vibration transmitted to the support frame 2c due to the micro-vibration in normal conditions to the support frame 2c is not greater than the allowable vibration value in the vibration-sensitive area A₂. Further, in this base isolation device 10, vibration energy will be absorbed by plastic deformation of the lead plug 13 and horizontal soft deformation of the rubber 11 in an earthquake.

In addition, an oil damper 15 (damping device) for damping horizontal relative displacement by oil viscosity is placed between the support frame 2a and the foundation 3 in the vibration-sensitive area A₁.

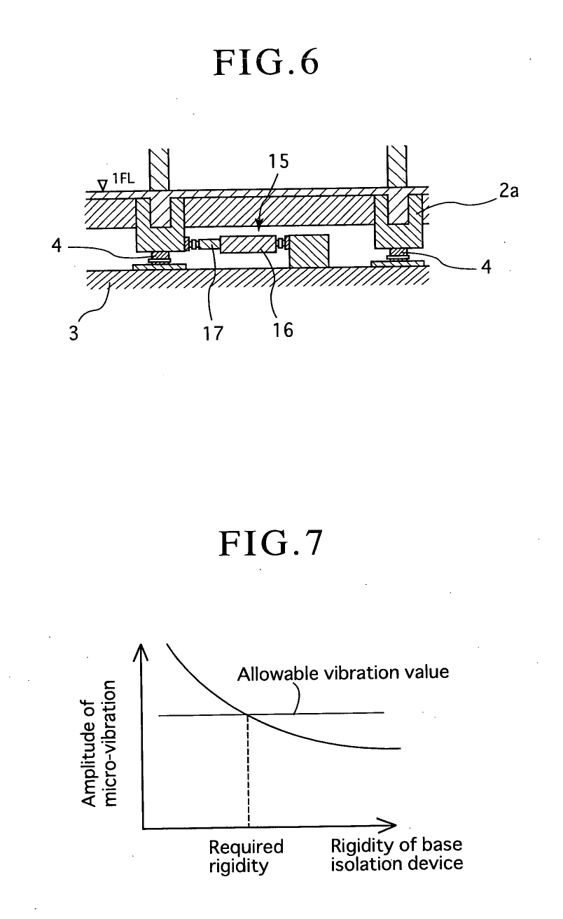

In this oil damper 15, as shown in FIG. 6, a piston 17 is provided movably inside a cylinder 16 and oil is filled between them. An end of the cylinder 16 is fixed on the foundation side 3 and an end of the output shaft of the piston 17 is fixed on the support frame side 2a.

Further, among the support frames 2a and 2b having the smaller allowable vibration value and the support frames 2c and 2d having the larger allowable vibration value, as shown in FIG. 1, the support frames 2a and 2c located at a lower portion of the structure are connected to one another, however, the support frames 2b and 2d located at an upper portion of the structure are separated from one another.

According to the base isolation structure configured as above, the semiconductor manufacturing plant 1 is partitioned into the vibration-sensitive area A₁ having vibration-sensitive equipments arranged thereon and having an extremely small allowable vibration value and the other area A₂ having a larger allowable value than that of the vibration-sensitive area A₁, and in each of the areas A₁ and A₂, the base isolation devices 4 and 10 having such vertical and horizontal rigidity that micro-vibration transmitted is smaller than the allowable vibration value in each of the areas A₁ and A₂ are disposed, and therefore, in normal conditions, the micro-vibration transmitted via the base isolation devices 4 and 10 to the support frame portions 2a to 2d can be kept to be not greater than the allowable vibration value in each of the areas A₁ and A₂.

Moreover, especially in the area A₁, because the number of the base isolation device 4 etc. or its area is selected so that, when the allowable vibration value in the area A₁ is not greater than 1.0 μm, a horizontal natural frequency of a base isolation layer composed of the base isolation device 4 and the like is not less than 3 Hz, and further, when the allowable vibration value is not greater than 0.5 μm, a horizontal natural frequency is not less than 4 Hz, displacement response due to resonance of the plant 1 can be suppressed small and it is secured that the displacement response caused by the micro-vibration usually produced can be not greater than the allowable vibration value.

As a result, the micro-vibration usually produced will not be amplified by the base isolation devices 4 and 10, which will not produce a negative effect that the micro-vibration may exceed the allowable vibration value in each of the areas A₁ and A₂, and therefore, a stable operation can be secured.

Also, in an earthquake, according to cooperation between the base isolation device 4 using the rigid sliding bearing placed at the areas A₁, A₂ and the base isolation device 10 using the laminated rubber bearing containing the lead plug, a stress or deformation generated in the support frames 2a to 2d may be reduced and a high base isolation effect for the whole plant 1 can be developed.

In addition, because low frictional polytetrafluoroethylene having a friction coefficient of about 0.013 is used for each of the sliding plate 5 and the sliding surface 8a in the base isolation device 4, sliding movement is initiated by small horizontal force acting on in an earthquake, and as a result, an input itself to the plant 1 can be reduced, and consequently acceleration response generated in the plant 1 can be decreased, as shown in a graph on the lower side of FIG. 9.

Further, because the oil damper 15 for damping horizontal relative displacement is provided between the plant 1 and the foundation 3, even if sliding movement is early generated, exertion of damping effect by the oil damper 15 can damp vibration which would otherwise be transmitted from the foundation 3 to the whole plant 1 via support frames 2a to 2d, resulting in smaller horizontal displacement of the whole plant 1.

Therefore, because both of high rigidity achieved by using the rigid sliding bearing in normal conditions and low rigidity in an earthquake can be satisfied, it can be secured that displacement of the plant 1 caused by the micro-vibration in normal conditions is not greater than the allowable vibration value, and also acceleration response of the plant 1 in an earthquake can be suppressed to be small. As a result, a fall of the equipment etc. on the support frames 2a to 2d or large damage to the buildings 1a and 1b can be prevented from occurring.

In such case, since rigidity for the micro-vibration varies with the base isolation device 4 using the rigid sliding bearing and the base isolation device 10 using the laminated rubber bearing containing the lead plug, the support frames 2a, 2b and the support frames 2c, 2d show different amplitude of vibration from one another. However, since each of the upper portions of the structure, i.e. the support frames 2b, 2d where amplitude difference is large is separated from one another, mutual interference can be avoided.

Further, in the embodiments, because the present invention has been explained in relation to the case where the present invention is applied to the semiconductor manufacturing plant which has been difficult to provide base isolation ability because of a low allowable vibration value, the base isolation device 10 using the laminated rubber bearing with the lead plug having a comparatively large rigidity is placed even in the other area A₂ having a larger allowable vibration value than the vibration-sensitive area A₁, but, it is not intended to limit to this, it is also possible to place another base isolation device such as a base isolation device using a laminated rubber bearing or a laminated rubber bearing having high damping effect, a base isolation device using an elastic sliding bearing or the like, when an allowable vibration value is large sufficiently in the support frame 2c of the building 1b.

It is also possible to use a viscous elastic damper or spring etc. as a damping device in place of the oil damper 15 described above. Further, when displacement of the structure will not become large or when deformation could be suppressed by an increase in a sliding factor in the base isolation device using a sliding bearing, it may be also possible to omit the damping device such as the oil damper or the like.

Also, it is not intended to limit the sliding plate 5 of the base isolation device 4 to the polytetrafluoroethylene coating plate described above, and if possible from considering acceleration response performance, a stainless plate may be used in place of it.

### EXAMPLE

An exemplary configuration of a base isolation device for achieving a base isolation layer having a horizontal natural frequency of not less than 4 Hz was studied for a structure having a weight M of 10,000 ton and an allowable vibration value of 0.5 μm.

First, forty base isolation devices using a rigid sliding bearing having horizontal rigidity of 300.0 tonf/cm are disposed and in addition, twenty base isolation devices using a laminated rubber bearing having horizontal rigidity of 1.0 tonf/cm are disposed.

As a result, horizontal rigidity K of the base isolation layer may be expressed as follows:
K=(300.0×40)+(1.0×20)=12,020 tonf/cm

Therefore, a horizontal natural frequency f of the base isolation layer may be expressed from the gravitational acceleration g=980 cm/s² as follows:
f=1/(2π)×(K·g/M)^{1/2}=5.4 Hz

Then, the frequency of not less than 4 Hz may be obtained.

### INDUSTRIAL APPLICABILITY

According to the base isolation structure of the present invention, there is no such a possibility that micro-vibration usually produced does not exceed a requested allowable vibration value, therefore, it is possible to secure stable operation. In addition, it is also possible to prevent heavy damages from occurring by developing base isolating effects in earthquake. Accordingly, a structure such as a semiconductor manufacturing plant having vibration-sensitive equipments can be effectively isolated from earthquake.

1. Abase isolation structure comprising: a structure having micro vibration-sensitive equipments; a foundation of the structure; and a base isolation device between the structure and the foundation,
wherein the base isolation device has a rigid sliding bearing and a rigidity in vertical and horizontal directions such that micro-vibration transmitted to the structure is less than an allowable vibration value determined according to the degree of the reluctance of the micro vibration-sensitive equipments.

2. The base isolation structure according to claim 1, wherein the allowable vibration value is not greater than 1.0 μm and a horizontal natural frequency of a base isolation layer formed by the base isolation device is set to not less than 3 Hz.

3. The base isolation structure according to claim 1, wherein the allowable vibration value is not greater than 0.5 μm and a horizontal natural frequency of a base isolation layer formed by the base isolation device is set to not less than 4 Hz.

4. The base isolation structure according to claim 1, wherein a friction coefficient of the base isolation device using the rigid sliding bearing is not greater than 0.02, and further, a damping device for damping horizontal relative displacement is provided between the structure and the foundation.

5. The base isolation structure according to claim 4, wherein the base isolation device using the rigid sliding bearing has sliding surfaces facing one another, and each of the sliding surfaces is made of polytetrafluoroethylene.
